(19) United States
(12) Patent Application Publication
(10) Pub. No.: US 2007/0120697 A1
(43) Pub. Date: May 31, 2007

(54) Method and device for determining a location and orientation of a device in a vehicle

(76) Inventors: Ramy P. Ayoub, Arlington Heights, IL (US); Brian J. Sibilsky, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/288,475

(22) Filed: Nov. 29, 2005

(51) Int. Cl. G08B 21/00; H04N 9/47; H04N 7/18

(52) U.S. Cl. 340/686.1; 348/95; 348/61

(57) ABSTRACT

Systems, methods, and devices for accurately determining the location and orientation of adevice in a vehicle are disclosed. The ability of a device to automatically determine its location in a vehicle by using images from a camera or distance measurements is provided. The images or distance measurements are compared to previously stored data, and an image recognition algorithm or pattern recognition algorithm is used to determine the closest match and the location of the device. The camera is also configured to rotate itself such that the camera lens is substantially aligned with the user interface of the device. Upon orienting itself in this manner, the camera is configured to capture an image which allows the device to determine which occupants of the vehicle are able to access the device. In other embodiments, the orientation of the device can be determined by determining the offset angle between a reference line and the user interface of the device. The occupants having access to the device can be determined with reference to a look-up table of angles and vehicle areas. The operation of the device can advantageously be modified based upon its location and which occupants are able to access the device.

### CROSS-REFERENCE TO RELATED APPLICATIONS

This application is related to the following commonly-owned applications, the contents of which are hereby incorporated by reference: U.S. Application No. ______ entitled “System and Method for Controlling the Processing of Content Based on Zones in Vehicles,” filed concurrently under Attorney Docket No. CM08859TC; U.S. Application No.______ entitled “System and Method for Providing Content to Vehicles in Exchange for Vehicle Information,” filed concurrently under Attorney Docket No. CM08860TC; U.S. Application No. ______ entitled “System and Method for Controlling the Processing of Content Based on Vehicle Conditions,” filed concurrently under Attorney Docket No. CM08861TC; and U.S. Application No.______ entitled “System and Method for Modifying the Processing of Content Based on Vehicle Conditions,” filed concurrently under Attorney Docket No. CM08857TC.

### FIELD OF THE INVENTION

The present invention is generally related to the field of telematics, and more particularly to systems, devices, and methods for determining device location and/or orientation and device accessibility within a vehicle.

### BACKGROUND OF THE INVENTION

Without limiting the scope of the invention, its background is described in connection with the field of telematics. In a general sense, telematics refers to the integration of telecommunications, entertainment and information. Telematics includes the sending, receiving, and storing of information via telecommunication devices and systems.

Vehicular telematics systems generally comprise an in-vehicle communication and positioning system having many useful features to assist drivers and passengers and provide features for safety and convenience, such as roadside assistance, navigation, telephony, entertainment, and information. The adoption of vehicular telematics systems is becoming more widespread.

Numerous aftermarket communication devices are entering the market, many with lower cost and greater functionality than devices that come integrated in the vehicle. Vehicle operators and passengers are purchasing such products in greater numbers, and will continue to do so in the future. These products may be mounted in the vehicle through special car kit adaptors or generic stands and can be installed by either professionals or “do-it-yourself” users. A user can purchase an aftermarket device and install it anywhere in the vehicle as most aftermarket installation kits do not mechanically restrict the installation of the device, due to the generic nature of the installation kits. Furthermore, the user can orient the device in any direction she desires. The unrestricted installation of aftermarket communication devices by end-users has led to a number of issues, as discussed further below, which has in turn led to a need for the present invention.

As mentioned above, the installation of aftermarket communication devices by end-users has led to a number of issues. For example, an end-user may choose to ignore a user manual that recommends an installation location for a video screen for a DVD player, and may install the device in a dashboard of a car, where it is viewable by the driver. A prior attempt to solve this problem is to provide a user interface which merely asks the user whether she is the driver, and if the user indicates that she is the driver, the DVD player is disabled. A solution of this type is easily circumvented by simply indicating (falsely) that the user is not the driver. Accordingly, such solutions fail to adequately address the issue associated with the inability of aftermarket devices to accurately locate their position in a vehicle. In addition, there are numerous factory installed and portable devices in the vehicle that are re-locatable and/or may be re-oriented within the vehicle.

The location and/or orientation of an aftermarket device in a vehicle can affect its performance. For example, a hands-free system for communication utilizing multiple-microphone voice reception preferably forms an acoustic beam toward the speaker (for example, the driver), which has the effect of amplifying the driver's speech, as well as filtering out noise from the area outside the beam. Without information indicating where the device is located and/or oriented relative to an occupant of the vehicle, the performance of the device suffers.

Thus, a need has arisen for a system and method for determining the location and orientation of a device in a vehicle that overcomes the problems described above.

### BRIEF DESCRIPTION OF THE DRAWINGS

Embodiments of the inventive aspects of this disclosure are best understood with reference to the following detailed description, when read in conjunction with the accompanying drawings, in which:

FIG. 1 depicts a perspective view of a portion of a cabin of a vehicle including an aftermarket device;

FIGS. 2A and 2B depict perspective views of exemplary pre-stored vehicle profiles;

FIG. 3 depicts a plan view of a scan profile of an aftermarket device;

FIG. 4 depicts a plan view of a scan profile of an aftermarket device within a cabin of a vehicle;

FIGS. 5A and 5B depict plan views of the orientation rotation angle in a cabin of a vehicle and location areas in the cabin;

FIG. 6 depicts a lookup table showing the mapping of rotation angles to location areas to determine occupant accessibility;

FIG. 7 depicts a plan view of a device at a location within a cabin of a vehicle; and

FIG. 8 depicts a plan view of a device at another location within a cabin of a vehicle.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION OF THE INVENTION

The present invention provides for systems, methods, and devices that improve upon prior attempts to solve such problems by providing a more accurate way for a device to determine its location and/or orientation in a vehicle. The device can be a factory installed device, a later installed device (e.g., aftermarket device) or a portable device. For simplicity, the examples below describe installation of an aftermarket device. The device is configured to determine its location within a vehicle by using data obtained from a rotatable location determination unit. In accordance with certain embodiments of the present invention, the location determination unit comprises a rotatable camera configured to capture images of the vehicle cabin from the vantage point of the device, which are compared to one or more stored vehicle images. These stored images are preloaded on the device by the manufacturer or distributor and can be specific to a particular make, model and year of a vehicle, or may be generic vehicle cabin images. An image recognition algorithm is used to determine the closest match. As such, the operation of the device can be modified or controlled based on the location of the device within the vehicle. For example, if the device is located in the front of the vehicle, the device may have limited/restricted operation (i.e., at least some of the features of the device are disabled), whereas, if the device is located in the rear of the vehicle, the device may be fully operational (i.e., all features of the device are enabled).

The camera is also configured to rotate itself such that the camera lens is substantially aligned with the user interface of the device. Upon orienting itself in this manner, the device is able to determine which occupants of the vehicle are within view of the camera and hence able to access the device. The operation of the device can be modified or controlled based on which occupant(s) can access the device. For example, the device may have limited/restricted operation if the driver can access the device while the vehicle is in motion, whereas the device may be fully operation if a passenger of the vehicle can access the device while the vehicle is in motion.

In accordance with other embodiments of the present invention, the rotatable location determination unit may comprise a distance measuring device, wherein the device may determine its location within a vehicle by using distance measurements from the location determination unit to any of a plurality of surfaces in the vehicle cabin. Laser, acoustic, radar, or other techniques may be used to obtain the distance measurements. Self-location is achieved by determining if the location and/or orientation of the device has changed, and performing a 360-degree scan of the vehicle cabin to develop a profile of the vehicle cabin. This distance scan of the cabin is compared to a known cabin profile using pattern matching algorithms (such as those used in face recognition devices) to determine the location of the device in the vehicle. The orientation of the device can be determined by determining the angle of rotation between a reference line and the user interface of the device. The angle of rotation can be determined by use of internal sensors, such as potentiometers or gyroscopes. By determining device location and orientation, the occupant(s) of the vehicle to which the device is directed can be determined. The operation of the device can be modified or controlled based on the occupant(s) to whom the device is directed. The accurate self-location and orientation capabilities of the present invention therefore provide benefits in the way of improved performance.

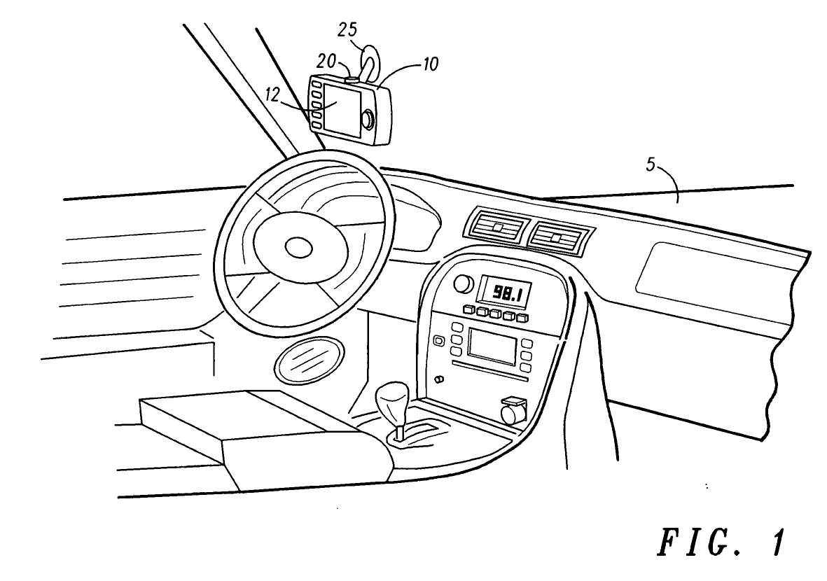

Reference is now made to FIG. 1, which depicts a perspective view of a portion of a cabin of a vehicle 5. The vehicle 5 may be, for example, an automobile, truck, bus, RV, subway, train, boat, plane, spacecraft, or other type of means of transportation.

As shown in FIG. 1, an aftermarket electronic device 10 is located in the cabin of the vehicle 5. The device 10 may comprise a user interface such as a graphical user interface rendered on a display screen 12 as shown in FIG. 1. In other embodiments, the device 10 may comprise an audio device or other device that does not include a display screen or a graphical user interface. The device 10 may comprise a microprocessor and software for controlling the microprocessor. Examples of device 10 include, without limitation, communication devices, navigation devices, graphical user interface devices, entertainment devices, etc. The device 10 may perform any of a variety of functions pertaining to, for example, navigation, real-time traffic information, music, movies, games, entertainment, telephony, emergency calls, security, websites, e-mail, calendars, personal information manager (PIM), audio, video, images, and/or multimedia content, etc. The device 10 may be portable (such as an iPod® media player or a cellular telephone, for example), and therefore its location may be continually subject to change. Mounting hardware 25 that may form a part of the device installation kit allows the user to secure the device 10 in the vehicle 5. The example in FIG. 1 shows a gooseneck type mounting hardware that allows the device 10 to be installed in the vehicle 5, but other mounting systems may be used.

The device 10 may procure and/or render content, as described in more detail in the following commonly-owned applications, the contents of which have been incorporated by reference: U.S. Application No.______ entitled “System and Method for Controlling the Processing of Content Based on Zones in Vehicles,” filed concurrently under Attorney Docket No. CM08859TC; U.S. Application No.______ entitled “System and Method for Providing Content to Vehicles in Exchange for Vehicle Information,” filed concurrently under Attorney Docket No. CM08860TC; U.S. Application No.______ entitled “System and Method for Controlling the Processing of Content Based on Vehicle Conditions,” filed concurrently under Attorney Docket No. CM08861TC; and U.S. Application No.______ entitled “System and Method for Modifying the Processing of Content Based on Vehicle Conditions,” filed concurrently under Attorney Docket No. CM08857TC.

The device 10 comprises a location determination unit 20 operatively coupled to the microprocessor of the device 10. The location determination 20 may be a separate unit coupled to the device 10 or may be integrated with device 10. In accordance with certain embodiments of the present invention, the location determination unit 20 comprises a rotatable camera lens. The camera lens is configured to rotate 360 degrees and capture video or images at regular intervals during the rotation. Thus, the camera is configured to point in a variety of directions and capture images from a variety of angles. The captured images or frames of video may comprise images of the interior of the vehicle cabin. The video frames or captured images are compared to stored images of the vehicle cabin. The stored images may be retrieved from a remote database or may be stored locally in a memory in the device 10. The memory is operatively coupled to the microprocessor of the device 10. The stored images may comprise a plurality of images of various views of the vehicle cabin, including images of occupants and/or seating arrangements. The device 10 identifies the best match between the captured images and the stored images. Image recognition algorithms known in the art or after-arising algorithms may be used to perform this task.

In addition, the camera may be used to determine which vehicle occupants have access to the device 10. The camera may be rotated to align itself with the front surface (typically the user interface) of the device 10. The alignment may be accomplished, for example, by an electronic sensor, mechanical means, or electromechanical means. For example, a click-lock mechanism may be used to achieve the alignment. Once aligned with the user interface, the camera can identify which occupants are within view of the camera, and hence within view of the user interface.

In accordance with various other embodiments of the present invention, the location determination unit 20 may comprise a wireless distance meter. The wireless distance meter may determine distance measurements by any of several methods. For example, the wireless distance meter may comprise an optical distance meter such as a laser distance meter which is based on determining the time from emission of light to reception of its reflection, or an acoustic distance meter, such as an ultrasonic distance meter, which is based on determining the time from emission of a sound pulse to reception of its reflection. In other embodiments, the wireless distance meter may comprise a radar distance meter which is based on reflection of electromagnetic waves. Since the size of a vehicle cabin can be relatively small, the power of the laser, acoustics, or radar, etc. used by the wireless distance meter is low, so as to minimize reflections from sources outside the vehicle.

It will be appreciated by those of skill in the art that the foregoing types of wireless distance meters are provided as illustrative examples only and are not to be considered as exhaustive or limiting. The present invention may be practiced with other types of distance meters that are known by those of skill in the art or will arise in the future.

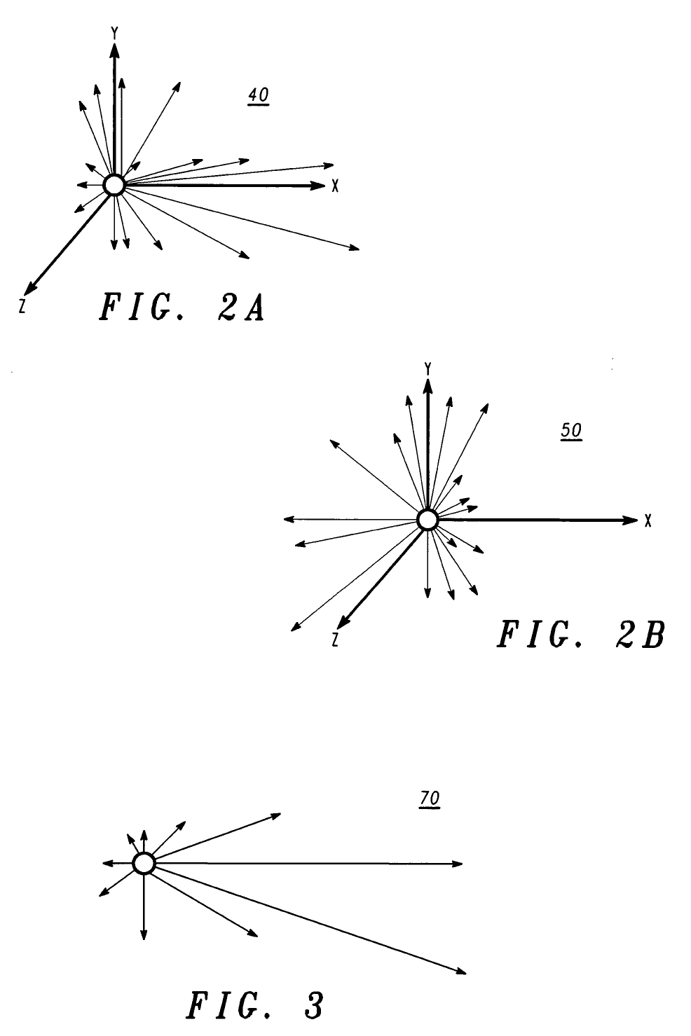

The device 10 may comprise a memory which stores one or more vehicle profiles, examples of which are shown in FIGS. 2A and 2B. A profile may be represented as one or more photographic images, in the case of the camera based location determination unit, or as a collection of distance measurements (as shown in FIGS. 2A and 2B), in the case of a distance measurement based location determination unit. In the case of a distance measurement based location determination unit, the profiles stored are two-dimensional or three-dimensional profiles that may generically capture the different cabins available. The exact dimension depends on the storage capabilities of the device 10. In addition to generic two- or three-dimensional vehicle profiles, vehicle make, model and year specific profiles may be stored in memory. The vehicle profile may include information pertaining to the dimensions and configuration of the vehicle cabin, and may include various distance measurements between known points in the cabin.

In some embodiments, the vehicle profiles may be retrieved by the device 10 from a remotely located storage medium which contains a plurality of vehicle profiles. The remotely stored vehicle profiles may include a profile for a specific year, make, and model of vehicle (e.g., 2004 Hummer H2, etc.). In addition, the remotely stored vehicle profiles may include a profile for a class or category of vehicle (e.g., sedan, SUV, van, coupe, convertible, wagon, hatchback, pickup, luxury, etc.). Upon powering on the device 10 for the first time, the user may be prompted to select the appropriate vehicle profile via the user interface of the device 10. The user may change the profile if desired, for example, if the device 10 is later used in a different vehicle. In yet another embodiment, the device 10 may retrieve the stored vehicle year, make and model information from the vehicle directly, if direct vehicle connectivity exists.

The device 10 determines its location by performing a 360-degree scan of the vehicle 5 and taking distance measurements, or capturing images, at regular intervals during the scan. The wireless distance meter rotates while it transmits light (or sound or electromagnetic pulses, etc.) and takes measurements. The measurement intervals are of a frequency sufficient to allow the device 10 to form an accurate representation of its surroundings. The scan rate and sample rate of the distance meter may vary from device to device, but the scan and sample rate of the device should match those of the stored profiles, to enhance the probability of successful pattern matching. In order to differentiate between occupants and the sides of the cabin, the device 10 develops a three-dimensional cabin profile of the vehicle 5, relative to the position of the device 10.

The device 10 can be programmed to perform the scan upon the occurrence of a specific event. For example, the device 10 may perform the scan when the device is powered on. In addition, the device 10 may perform the scan periodically during run time, such as every n minutes, etc. Furthermore, the device 10 may perform the scan every time the position or orientation of the device 10 is changed. The location of the device 10 may be tested by taking a select known measurement and comparing it to the identical measurement taken during the previous power-on cycle. If the measurements are the same, then the location of the device 10 has not changed. Otherwise, the device 10 has moved and therefore proceeds to determine its new location by performing a scan.

A plan view of an exemplary scan profile 70 of the device 10 of FIG. 1 is depicted in FIG. 3. A three-dimensional scan provides height location data, in addition to the x-y data depicted in FIG. 3.

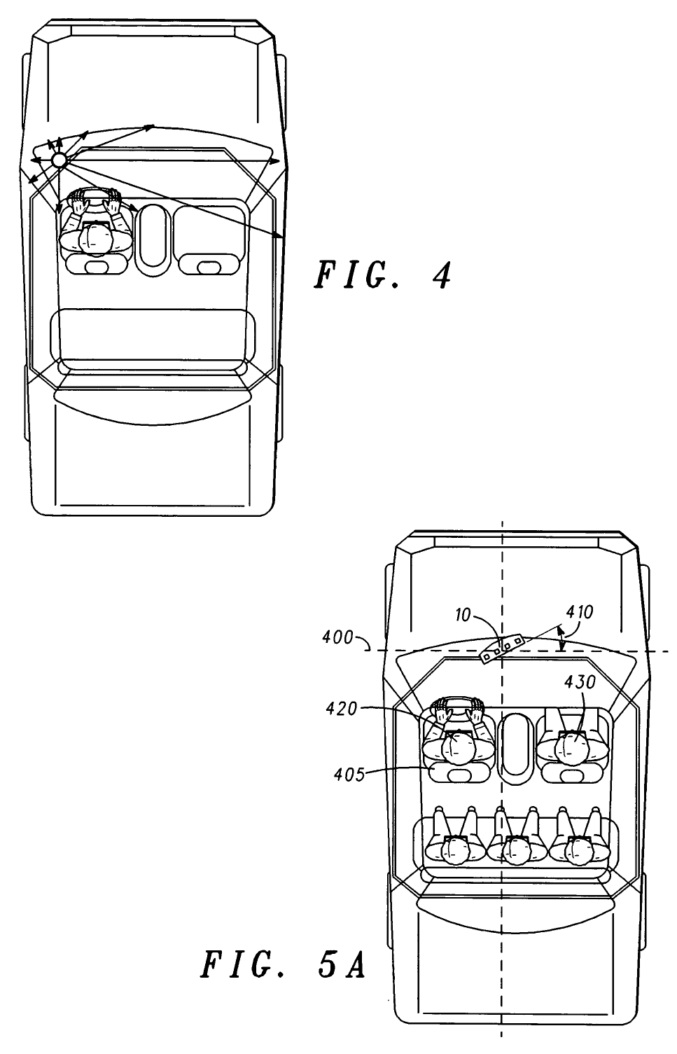

By overlaying the measured vehicle profile 70 shown in FIG. 3 over the stored profiles (generic or vehicle specific) 40 and 50 as shown in FIGS. 2A and 2B, the device 10 can identify the best match between the measured and stored profiles. In order to make the successful match and identification, pattern recognition algorithms, such as the MIT Media Labs 96 Principle Component Analysis (PCA) algorithms may be implemented to perform the pattern recognition, but one of ordinary skill in the art will appreciate that several other commercially available or after-arising algorithms may be used to perform this task. The measured profile 70 is compared, using pattern recognition against known stored profiles 40 and 50 in order to make this determination. In this case, measured profile 70 is most similar to stored profile 40, allowing the device 10 to determine that it is located in the front of the vehicle cabin, on the driver side, as depicted in FIG. 4.

The stored vehicle profiles may indicate through specific distance vectors, the locations of windows, sunroofs, moonroofs, or convertible tops, so that the device 10 can identify the correct profiles in the event of an open window, sunroof, or moonroof, or a lowered convertible top. The distance meter does not receive a reflection in the areas of an opening, and may assume that those particular distance measuring vectors are pointing to an opening in the vehicle.

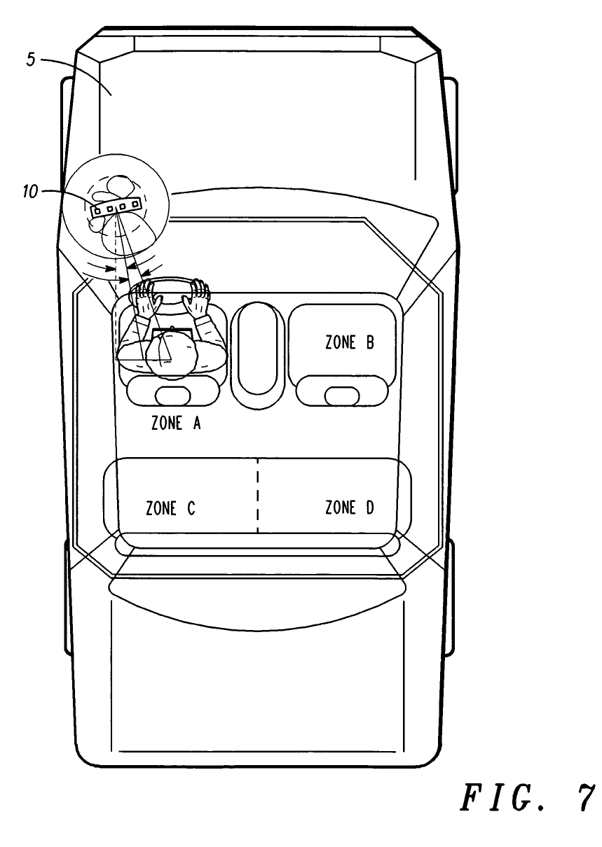

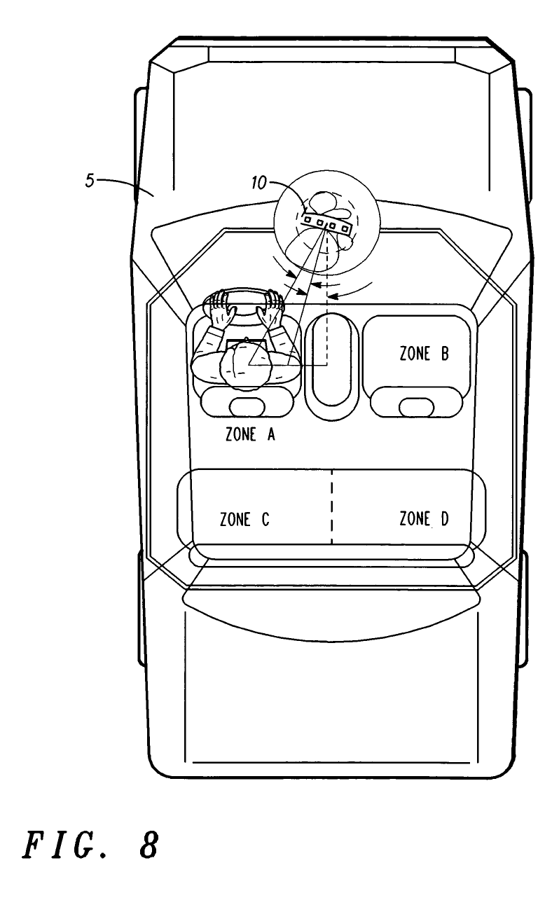

In some embodiments, the user may program the location of the device 10 after installation. For example, the device 10 may include a touch screen display which shows a mapping of the vehicle 5 and prompts the user to touch where the device 10 is located. In addition, the user interface of the device 10 may prompt the user to select a zone in which the device 10 is located. FIG. 7 depicts an example of a plurality of predefined zones from which to choose from. In the example illustrated in FIG. 7, the zones include Zone A for the front driver side, Zone B for the front passenger side, Zone C for the rear driver side, and Zone D for the rear passenger side of the vehicle 5. FIG. 7 is for illustrative purposes only, and it should appreciated by those of skill in the art that a lesser or greater number of zones may be provided. In addition, mapping of vehicle 5 into various zones may vary depending on such factors as the particular vehicle or the type of vehicle, the type of device, and the amount of memory, etc.

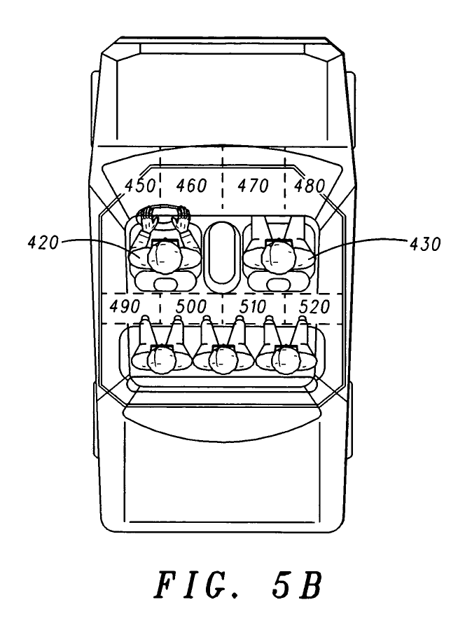

In addition to determining its location, the device 10 is also capable of determining its orientation in the vehicle 5. In other words, the device 10 is capable of determining the direction of its user interface, which may comprise, for example, a display screen or a microphone/speaker operatively coupled to the microprocessor of the device 10, relative to the occupant(s) of the vehicle 5. This is useful for enhancing device performance in the vehicle 5, since device location and orientation information can be used to determine the accessibility of the device 10 to the occupants in the vehicle 5. The orientation of the device 10, relative to center, can be detected by mechanical, electrical, or electromechanical devices known in the arts or after-arising, such as potentiometers or gyroscopes, etc. The orientation of the device 10 in the vehicle 5 can be determined by determining the offset angle 410 between a reference line 400 and the user interface of the device 10 as shown in FIG. 5A. In the example shown in FIG. 5A, the reference line 400 is depicted as substantially parallel to a seat 405 proximate the device 10. The reference line 400 may be drawn elsewhere, however, depending on such factors as the type of vehicle, cabin configuration, device functionality, and device placement, etc. The offset angle 410 is the angle between the reference line 400 and a line across the front surface (typically the user interface) of the device 10. By using potentiometers in the neck of the device 10, this angle 410 can be determined. One of ordinary skill in the art will appreciate that there are other methods for finding the offset angle known in the arts, such as internal position sensors in the device 10. GPS devices may provide additional information such as velocity vectors that aid the device 10 in locating the front of the cabin, which aids in the overall determination of the orientation of the device 10.

The device 10 can be programmed to determine its orientation upon the occurrence of a specific event. For example, the device 10 may determine its orientation when the device is powered on. In addition, the device 10 may determine its orientation periodically during run time, such as every n minutes, etc. Furthermore, the device 10 may determine its orientation every time the orientation of the device 10 is changed. A change in the orientation of the device 10 may be determined by use of internal sensors such as potentiometers.

Thus by combining the location information and the orientation information of the device 10 in the vehicle 5, the device 10 may determine which occupant(s) of the vehicle 5 the device 10 is directed to and hence modify its operations to enhance its functionality to those occupants (e.g., disabled, partially operational, fully operational, or the like). FIG. 5A shows the device 10 located near the driver side of the vehicle. The device 10 may make this determination by performing the distance measurement and pattern recognition method or the image capture and image recognition method described earlier. In other embodiments, the device 10 may be in a fixed, known location due to, for example, factory installation or professional installation, but its orientation may be manipulated by the user and therefore its orientation is variable. The orientation of the device 10 is determined by measuring the offset angle 410 between the user interface (face) of the device 10 and the reference line 400. In the example of FIG. 5A, determining the offset angle 410 allows a determination that the device 10 is oriented toward the right side of the vehicle 5. By combining the location and orientation information of the device 10, the device 10 makes the determination that its accessibility is to the front passenger 430 of the vehicle 5, not the driver 420. As such, the present invention may allow the device 10 to be fully operational while the vehicle is in motion.

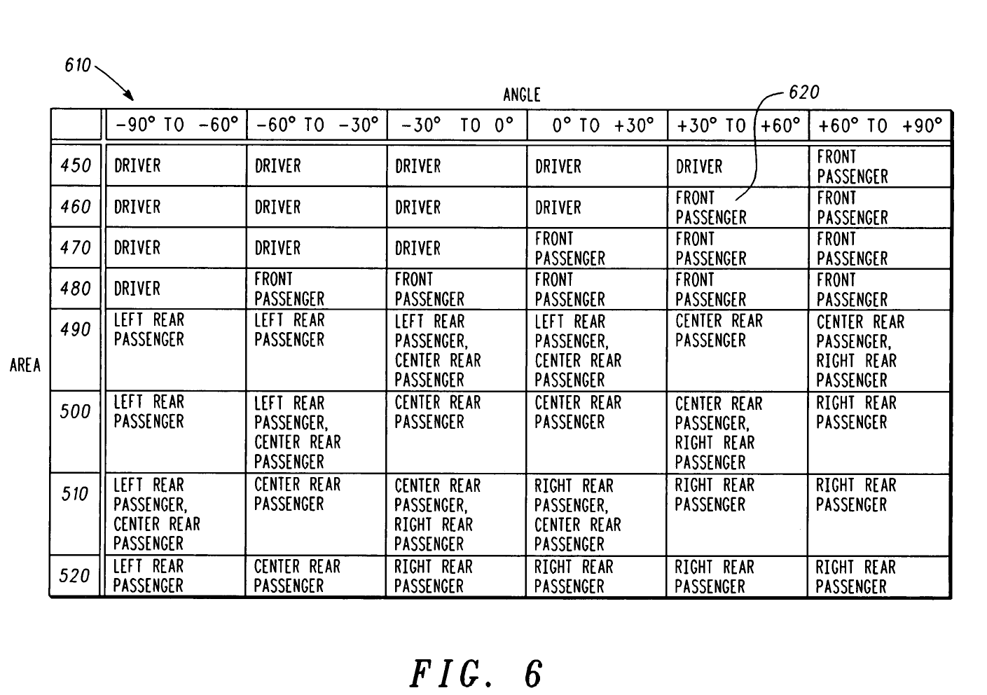

One method for making this determination is to first identify location areas in the vehicle as shown in the example of FIG. 5B. Location areas have been identified, such as areas 450, 460, 470, 480, 490, 500, 510, and 520. Then, by use of a lookup table 610 shown in FIG. 6, offset angles are mapped to location areas to determine occupant accessibility to the device 10. In some configurations, the device 10 may be accessible to more than one occupant, depending on the type of vehicle, the layout of the occupant seating, the occupant density, and the number of possible occupants, etc.

Therefore, referring to the example in FIG. 5A, device 10 is located on the dashboard of the vehicle 5 in area 460 and the rotation angle 410 is approximately +35 degrees. By looking up the intersection of location area 460 with a rotation angle between +30 degrees and +60 degrees in table 610, it can be determined that the passenger accessibility is as shown in entry 620—the front passenger 430. Therefore, device 10 in FIG. 5A can adjust its user interface and content as appropriate for the front passenger 430. The adjustment and control of the user interface and content are described in more detail in the related patent applications which have been incorporated by reference.

In the case of camera-based location determination units, an image of the vehicle cabin taken by the camera while it is aligned with the user interface can quickly provide accessibility information without the need for measuring orientation and rotation angles. The image identifies which users have accessibility to the device, by comparing stored known passenger location information with the image taken by the camera.

Although the above steps may have been described in a certain sequence, they need not be performed in the sequence described. In addition, the quantity, size, and configuration of the areas mapped for vehicle 5 may be varied. Furthermore, the angles in table 610 may be divided into smaller or larger ranges. Indeed, the resolution of table 610 may vary depending on such factors as the type of vehicle, the type of device, and the memory constraints of the device, etc. The likelihood of correctly identifying the occupant to which the device is accessible increases as the resolution of table 610 increases. Further still, although angles below −90 degrees and angles above +90 degrees are not shown in the example look-up table 610 for purposes of simplicity, it will be understood by one of ordinary skill in the art that the look-up table 610 may include additional angles (e.g., angles between +90 degrees and +180 degrees, and angles between −90 degrees and −180 degrees) so as to cover 360 degrees of rotation.

Once the device 10 has determined its location and/or orientation, it can perform and interact with the occupant(s) of the vehicle 5 in a much improved manner. For example, if the device 10 is a DVD player that determines it is located in the front of the cabin on the driver's side, the device 10 may modify or restrict its operation, for example, by disabling the video display and rendering audio only, or by disabling certain features when the vehicle is in motion. Such adjusted operation advantageously provides improved functionality. As another example, if the device 10 is a telecommunications device, an acoustic beam may be adjusted to emanate from the device 10 to the left of center of the device 10, as shown in FIG. 7, or to the right of the center of the device 10, as shown in FIG. 8. Such adjusted operation advantageously provides improved performance by amplifying the driver's speech, as well as filtering out undesirable background noise.

In addition, the device 10 may be communicatively coupled to a telematics control unit in the vehicle 5. The telematics control unit may be similar to that described in the related patent applications incorporated by reference above. Communicatively coupling the device 10 to the telematics control unit allows for further enhanced operation of the device 10. For example, operation of the device 10 may be restricted based on whether the vehicle 5 is in motion.

It should be understood that the inventive concepts disclosed herein are capable of many modifications. To the extent such modifications fall within the scope of the appended claims and their equivalents, they are intended to be covered by this patent.

What is claimed is:

1. A method of estimating a location of a device within a vehicle, the method comprising:
obtaining data from a rotating location determination unit of the device;
developing a vehicle profile based on the data obtained from the rotating location determination unit; and
comparing the vehicle profile to one or more known vehicle profiles to estimate the location of the device.

2. The method of claim 1 further comprising the act of modifying operation of the device based on the estimated location of the device.

3. The method of claim 1, wherein the act of obtaining data comprises capturing images of a plurality of views in the vehicle.

4. The method of claim 1, wherein the act of obtaining data comprises obtaining measurements of distance between the location determination unit and any of a plurality of surfaces in the vehicle.

5. The method of claim 4, wherein the act of obtaining measurements of distance comprises measuring time for reception of a reflection of a laser, an acoustic wave, or an electromagnetic wave emitted from the location determination unit.

6. The method of claim 1, wherein the act of comparing the vehicle profile comprises performing an image recognition algorithm or a pattern recognition algorithm.

7. The method of claim 1, wherein the act of obtaining data is performed periodically during run time.

8. The method of claim 1, wherein the act of obtaining data is performed upon powering on the device.

9. The method of claim 1, wherein the act of obtaining data is performed upon detection of a change in the location of the device relative to the vehicle.

10. The method of claim 1, further comprising the act of determining orientation of a user interface of the device.

11. The method of claim 10, wherein the act of determining orientation comprises measuring an offset angle between the user interface of the device and a line substantially parallel to a seat in the vehicle cabin.

12. The method of claim 10, wherein the act of determining orientation comprises determining a change in voltage using a potentiometer.

13. The method of claim 10, further comprising the act of modifying operation of the device based on the orientation of the user interface.

14. A method for determining accessibility of a device in a vehicle by an occupant of the vehicle, the method comprising:
capturing a plurality of images of the vehicle from a vantage point of the device via a rotating camera lens;
comparing the plurality of captured images to one or more stored vehicle images;
substantially aligning the camera lens with a user interface of the device; and
determining which occupant in the vehicle is within view of the user interface of the device.

15. The method of claim 14 further comprising the act of modifying operation of the device based on the act of determining.

16. The method of claim 14, further comprising the act of modifying operation of the device based on which occupant in the vehicle is within view of the user interface of the device.

17. A self-locating device for use in a vehicle, the device comprising:
a microprocessor;
a location determination unit operatively coupled to the microprocessor;
wherein the location determination unit is configured to rotate and obtain data used to develop a vehicle profile; and
a memory for storing one or more predetermined vehicle profiles,
wherein the memory is operatively coupled to the microprocessor.

18. The device of claim 17, wherein the location determination unit comprises is an acoustic distance meter, a laser distance meter, or a radar distance meter.

19. The device of claim 17, wherein the microprocessor comprises a means for comparing the developed vehicle profile to the one or more predetermined vehicle profiles.

20. The device of claim 17, wherein the device further comprises a microphone operatively coupled to the microprocessor.
